(19) United States
(12) Patent Application Publication
(10) Pub. No.: US 2007/0010289 A1
(43) Pub. Date: Jan. 11, 2007

(54) Detachable large display unit for cell phones

(76) Inventor: Arthur Mezue, Islandia, NY (US)

Correspondence Address: Arthur Mezue, 119 Scotchpine dr, Islandia, NY, 11749, US

(21) Appl. No.: 11/178,936

(22) Filed: Jul. 11, 2005

(51) Int. Cl. H04B 1/38

(52) U.S. Cl. 455/557

(57) ABSTRACT

The present invention discloses a portable electronic display unit which is rotatable, tiltable, and removably attachable to devices such as cellular phones which provides a user the option of a much larger viewing area and additional data storage for games, system files, information folders, etc. The device may also include a telescopic antenna that may be operable with other devices including computers, printers, TVs, PDAs, faxes, etc, to send and receive electronic signals and data further the device may also include large key pads, antiglare features, touch screen with zoom in features and is capable of being attached and removed when not in use.

### FIELD OF THE INVENTION

The present invention relates generally to a display device, and more particularly, to such a portable and detachable display device and unit which is rotatable, tiltable, and removably attachable to a cellular phones and provides a user the option of a much larger viewing area and additional data storage for games, system files, information folders, etc.

### BACKGROUND OF THE INVENTION

The recent advancement cell phone technology has led to breakthroughs that could only be appreciated on a large screen. The prior art discloses numerous different techniques for viewing or displaying devices. The conventional devices comprises inbuilt or permanently installed small viewing screens or display components. Many such systems, have screens that are to small for files to be displayed and does not offer additional storage space for the cell Phone. The Small nature of this installation causes increased complexity of service. Further these devices do not provide any system for large screen viewing. However, no such viewing or displaying system is available in the commercial market at the present time which is portable, simple, lightweight, rotatable, tiltable, and removably attachable to devices such as cellular phones, and provides a user the option of a much larger viewing area and additional data storage for games, system files, information folders, etc. or enables a user to individually and conveniently receive various wireless internet services in addition to the voice communication.

U.S. Pat. No. 5,659,361 discloses a LCD viewfinder for a camcorder that enables a user to take pictures while viewing the LCD viewfinder. The viewfinder system includes: an LCD (Liquid Crystal Display) viewfinder; a downwardly opened recess formed on a predetermined edge portion of the LCD viewfinder and having a first side wall, a second side wall, a back wall and a semicircular end; and a tiltable, rotatable and detachable compound joint assembly member fitted into the recess for tiltably, rotatably and detachably connecting the LCD viewfinder, whereby the LCD viewfinder can be tilted, rotated, and detached relative to the camcorder body. However, nothing is disclosed or suggested in this patent regarding a device which is simple, convenient, portable, and removably attachable to cellular phones, cameras, video cameras, or the like devices and provides a user the option of a much larger view viewing area and additional data storage for games, system files, information folders, etc.

U.S. Patent Publication No. 20030064685 discloses a portable communication apparatus with a digital camera comprises: a first housing including an upper portion, a lower portion, a receiving space hollowed between the upper portion and the lower portion, and a planar surface provided at the bottom of the receiving space, a lens housing protruding from the upper portion in a longitudinal direction, a digital camera lens of the digital camera being exposed in a longitudinal direction of the lens housing; a second housing including an upper portion having a phone LCD and a phone keypad with a plurality of keys and a lower portion having a PDA touch screen, the PDA touch screen being adjacent to the planar surface in the phone operation mode, the phone keypad and the phone LCD being adjacent to the planar surface in the PDA operation mode; and a biaxial hinge unit for connecting the second housing to the first housing to allow the second housing to rotate about two perpendicular axes with respect to the first housing. This construction is also complex and expensive. Further, this construction can not be used with various types of cellular phones, cameras, video cameras, or the like devices.

The features of the aforecited prior art disclose an expensive, complex, non portable device which can not be used with various types of cellular phones. The prior art devices are suitable for the specific individual purposes to which they address, however, no prior art that provides for a display device which is rotatable, tiltable, and removably attachable to a cellular phones, and provides a user the option of a much larger viewing area and additional data storage for games, system files, information folders, etc.

Therefore, the present scenario is punctuated by an emerging need for a utility viewing device which is simple, convenient, portable, and removably attachable to cellular phones,and provides a user the option of a much larger view viewing area and additional data storage for games, system files, information folders, etc.

### SUMMARY OF THE INVENTION

In view of the foregoing disadvantages inherent in the above-mentioned prior arts, the general purpose of the present invention is: to provide an improved combination of convenience and utility, to include all the advantages of the prior arts, and to overcome the abovementioned disadvantages/drawbacks of the prior art.

In one aspect, the present invention provides for a portable electronic display unit configured to be attached with an electronic device which comprises: a detachable viewing screen having viewing area configured to display TV, Text Messaging, Graphics, and multimedia, a memory storage that can be used by cell phone for data access and data storage e.g. to download games and movies with the cell phone and play the games and movies offline; speakers to provide audio and to enhance volume of the electronic device; a power knob configured to switch the detachable viewing screen on and off; a control button for controlling playing games from the electronic device; a video eye working in consonance with the cell phone, configured to send and receive live images; a battery unit configured to provide storage to a battery; a plugged in cell phone configured to import movies, mp3, emails, text messaging, games, pictures with ability for sharing display features; and a plurality of hinges with rotatable and tiltable connecting means for securing the cell phone to the electronic device.

In another aspect of the present invention, a portable electronic display unit is rotatable, tiltable, and removably attachable to devices such as cellular phones, and provides a user the option of a much larger viewing area and additional data storage for games, system files, information folders, etc. The device also includes a telescopic antenna that may be operable with other devices including computers, printers, TVs, PDAs, faxes, etc, to send and receive signal and may also have large key pad, antiglare features, touch screen with zoom in features. Further, portable electronic display unit is capable of being attached and removed when not in use.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

For a better understanding of the nature of the present invention, reference should be made in the detailed description taken in conjunction with the accompanying drawings in which:

FIG. 1 is perspective view of detachable display system constructed in accordance with the exemplary embodiments of the present invention;

FIG. 2 is the elevation view of the detachable display screen; constructed in accordance with the exemplary embodiments of the present invention;

FIG. 3 is the plane view of detachable display unit, constructed in accordance with the exemplary embodiments of the present invention;

FIG. 4 is the perspective view of detachable display system constructed in accordance with the exemplary embodiments of the present invention;

FIG. 5A and 5B are the lower view of the detachable display system constructed in accordance with the exemplary embodiments of the present invention; and

FIG. 6 and 6a are the top end view of the electronic device constructed in accordance with the exemplary embodiments of the present invention.

Like reference numerals refer to like parts throughout the several views of the drawings.

### DETAILED DESCRIPTION OF THE INVENTION

The exemplary embodiments described herein detail for illustrative purposes are subject to many variations and structure and design. It should be emphasized, however that the present invention is not limited to a particular detachable display system shown and described, rather, the principles of the present invention can be used with a variety of display system configurations and structural arrangements. It is understood that various omissions, substitutions of equivalents are contemplated as circumstances may suggest or render expedient, but is intended to cover the application or implementation without departing from the spirit or scope of the claims of the present invention.

The present invention provides a relatively inexpensive to produce, lightweight, simplified, and compact utility viewing device which provides a user the option of a much larger viewing area and additional data storage for games, system files, information folders, etc.

The present invention provides a display device which is rotatable, tiltable, and removably attachable to devices such as cellular phones, and provides a user the option of a much larger viewing area and additional data storage for games, system files, information folders, etc.

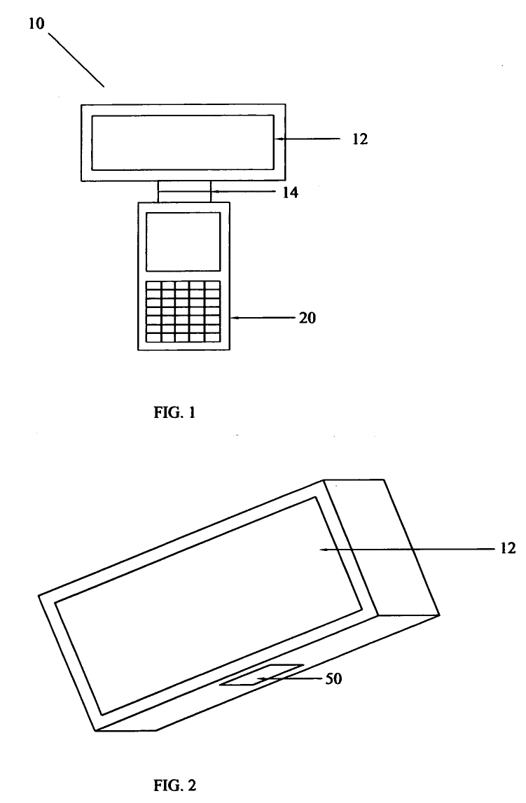

Exemplary embodiments of the present invention will now be described with reference to the accompanying drawings. The structure of detachable display system of the present invention will now be described with reference to FIGS. 1-6A. The detachable display system of the present invention illustrated as 10. The detachable display system 100 of the present invention comprises detachable display screen 12, electronic device 20, mould for the electronic device 22, flip electronic device cover 24, manual control for flip electronic device 26, top of the electronic device 28, LCD of the electronic device 30, key pad for the electronic device 32, plugged in electronic device 34, recharge socket 40, connection means 50, connection socket 52, speakers 60, power button 70, hinges 80, battery unit 90, charge point 92, video eye 94, and data storage (not shown).

In FIG. 1 detachable display system 100 comprises a detachable display screen 12 which is connected with electronic device 20 through connecting means 14. In FIG. 2 the detachable display screen 12 comprises connection socket 52 which is configured to coupled with electronic device 20 (not shown) through connection means 50 (not shown).

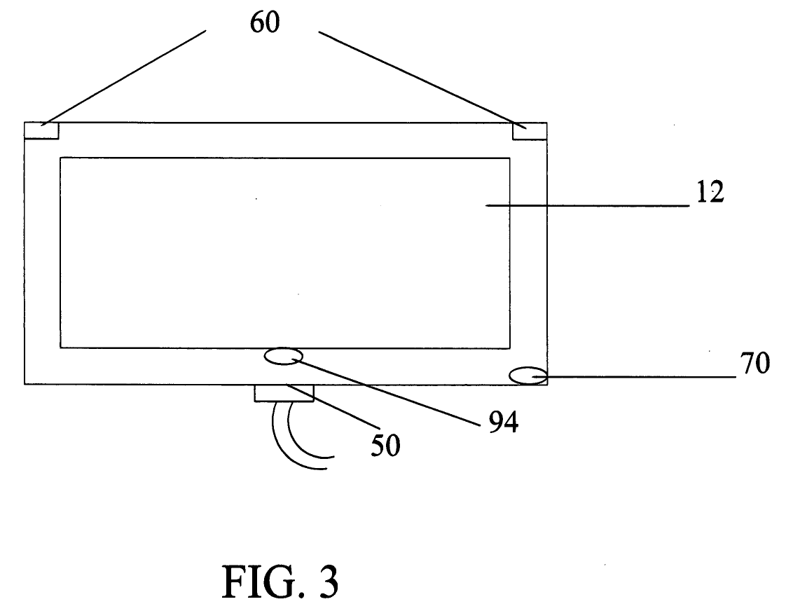

In FIG. 3 the large detachable screen 12 has a memory storage (not shown) that will allow a user to download games and movies with his/her electronic device (cell phone) 20 and play them offline. The memory storage can be any form of data storage. It can be at least one of random access memory (RAM) and/or read only memory (ROM). Information can be stored permanently until overwritten and/or stored temporarily for use while the unit is active. User can backup all files stored on the cell phone to the unit and can also store pictures and Mp3 music and play with the speakers 60 that are ear phone compatible. The speakers 60 are adapted to receive audio signals from the plugged in portable electronic device and produce high quality audio signals. The detachable display screen 12 is intended to display TV, Text Messaging, and any other data imported by the electronic device (cell phone) 20 in large form. The power on/off button 70 for the detachable display screen 12 and the electronic device (cell phone) 20 could also be used to switch between detachable display screens 12 and electronic device (cell phone) screen 30. The camera eye 94 is configured to provide face to face video conferencing. The alternate connection socket 52 may be used in place of socket 50 that connects the unit to the base.

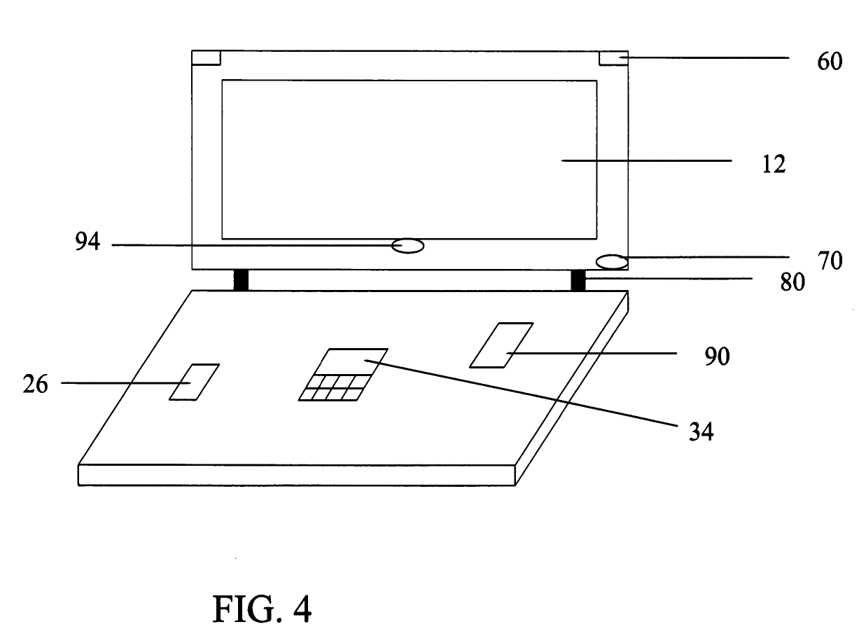

In FIG. 4 the assembled end product is tilt able. The video eye 94 will work in consonance with the camera unit of the cell phone to enable a user to see or send a live picture of him or her. The camera unit for taking still images and/or moving images can be used for video conferencing or any type of interaction that may need one or more images to be captured. For example, the video eye 94 may be used to detect user presence or to authenticate a user for access. The screen 12 can hold four or more images of people in a call waiting or conferencing scenario and a light pen or a finger touch on LCD could be used to zoom into a selected image. The detector method may use a transparent electrode or light emitting diodes and photo-transistor (not shown). A manual control 26 for flip electric device (cell phone) 20 and for playing games from the electronic device 20 (imported). The speakers 60 that will enhance the cell phone volume (not shown). The battery unit 90 at the back of the detachable display unit 10 is an option. The plugged in cell phone 34 will import movies, mp3, email, text messaging, games, and pictures with an ability to share its features i.e. red eye reduction and cropping, display and dialing features. The socket 52 connects the detachable display unit 10 to the base.

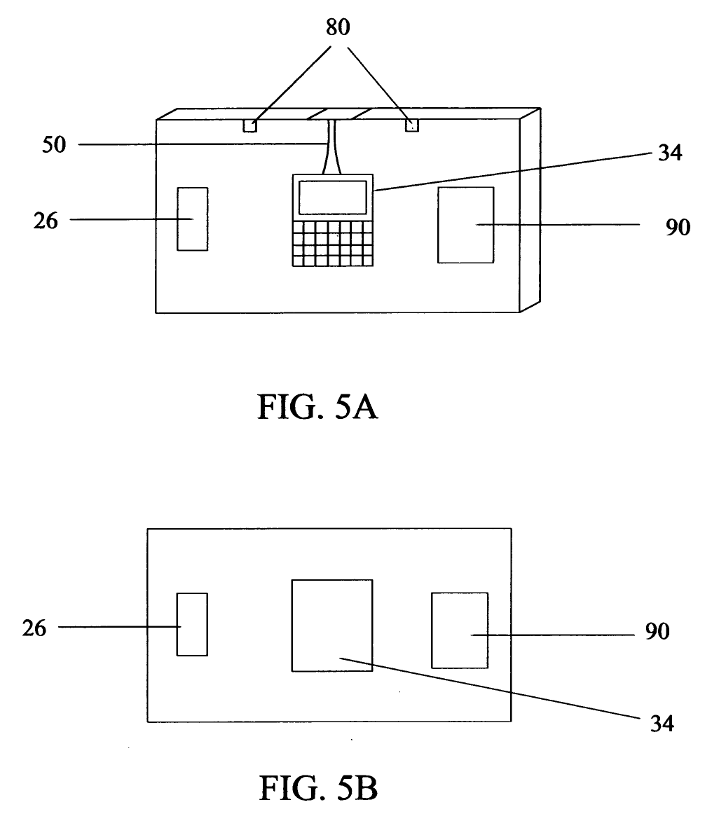

Referring to FIG. 5A & 5B, the lower part of the detachable display system 10 will be connected with hinges 80. This lower part houses the battery unit 90 and some control buttons 26 for the electronic flip device 20. It also has the charge point that charges the battery as it is used. Control buttons 26 could be used for games and for electronic flip phones in closed position. The hinges 80 for securing the two units—the upper and lower and come with a detachable top that can be switched for different electronic devices. The plugged in electronic device 34 will share all its capability with the detachable unit 10 while acting as the control unit 26 for the detachable unit 10. Compartment 90 for battery or electric power will also be used via socket 50. A mould 22 for the electronic device (cell phone) 20 the top area is removable for flexibility of serving various sizes and shapes of detachable electronic unit 10.

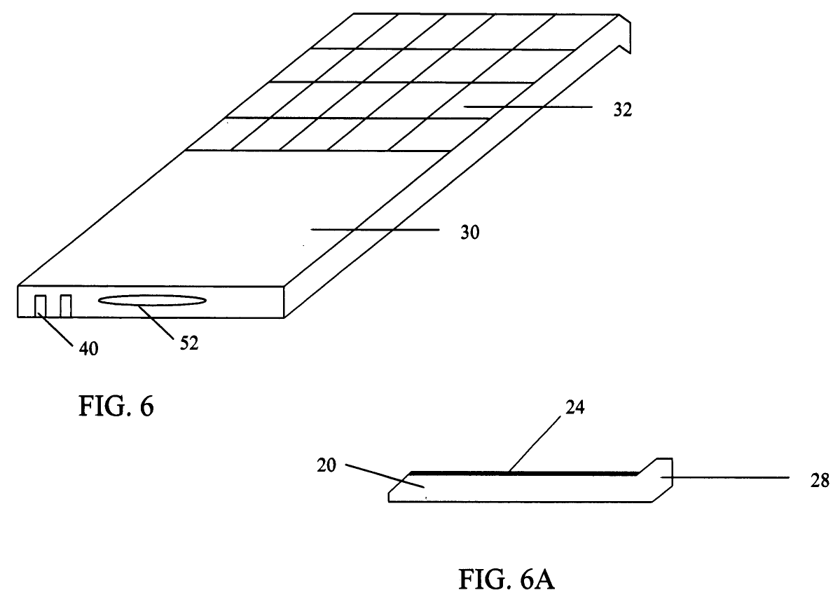

Referring to FIG. 6 & 6A a separate button will be used for navigation when electronic device (cell phone) 20 is closed. An electronic device (cell phone) 20 will import graphic and text data to the unit 10. The top of the cell phone depicted as 28. The LCD 30 of the electronic device (cell phone) 20 will include a detection means that will detect and shut off the cell phone LCD, allowing the device to utilize when the detachable unit 10 is switched on. Electronic device (cell phone) 20 comprises a key pad 32. The electronic device (cell phone) 20 controls the detachable unit 12 allowing it to receive and instantly display graphic images and text on the large screen 12. The recharge socket 52 configured to recharge electronic device (cell phone) 20 while detachable unit 12 is being utilized. The connection socket for the electronic device (cell phone) 20 and the detachable unit 12. The electronic device (cell phone) 20 connects to the detachable unit via the socket 40 and shares all the features with the unit.

Although a particular exemplary embodiment of the invention has been disclosed in detail for illustrative purposes, it will be recognized to those skilled in the art that variations or modifications of the disclosed brush, including the rearrangement in the configurations of the parts, changes in sizes and dimensions, variances in terms of detachably attachable is possible. Accordingly, the invention is intended to embrace all such alternatives, modifications and variations as may fall within the spirit and scope of the present invention.

I Claim:

1. A portable electronic display unit configured to be attached with cell phone comprising:
a detachable viewing screen having viewing area, said detachable viewing screen configured to display TV, Text Messaging, Graphics, and multimedia imported by cell phone
a memory storage configured to download games and movies with cell phone and play said games and movies offline;
speakers to provide audio and to enhance volume of said electronic device;
a power knob configured to switch said detachable viewing screen on and off;
a control button for controlling playing games from said electronic device;
a video eye working in consonance with cell phone configured to send and receive live images and display four or more images in cell conferencing scenario
a battery unit configured to provide storage to a battery;
a plugged in cell configured to import movies, mp3, emails, text messaging, games, pictures with ability for sharing display features; and
a plurality of hinges with rotatable and tiltable connecting means for securing said electronic display unit to said electronic device.
A charge unit (not shown) configured to provide charge to cell Phone, utilizing battery or electricity

2. A portable electronic display unit of claim 1 wherein said electronic device is a cell phone

3. A portable electronic display unit of claim 1 wherein said detachable viewing screen may be a Liquid Crystal Display (LCD) screen.

4. A portable electronic display unit of claim 1 wherein said memory storage is configured to store pictures/images and Mp3 music and play said pictures and Mp3 music with said speakers offline;

5. A portable electronic display unit of claim 1 wherein said plugged in cell phone share all its capability with said portable electronic display unit while acting as said control unit for said electronic device.

6. A portable electronic display unit of claim 1 wherein said connection means is configured to couple said portable electronic display unit configured to be attached with said electronic device.

7. A portable electronic display unit of claim 3 wherein said LCD is configured to provide much larger viewing area.

8. A portable electronic display unit of claim 1 further include a telescopic antenna that may be operable with other devices including computers, printers, TVs, PDAs, faxes, etc, to send and receive electronic signals and data.

9. A portable electronic display unit of claim 1 further may include large key pads, antiglare features, touch screen with zoom in features.

10. A portable electronic display unit of claim 1 wherein said detachable viewing screen is capable of being attached and removed when not in use.
